(19) United States
(12) Patent Application Publication
(10) Pub. No.: US 2008/0285755 A1
(43) Pub. Date: Nov. 20, 2008

(54) Method and Device for Accessing a Sim Card Housed in a Mobile Terminal

(76) Inventors: Sylvie Camus, Palaiseau (FR); David Piquenot, Saint Contest (FR); Anne-Sophie Dagorn, Caen (FR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/918,684

(22) PCT Filed: Apr. 5, 2006
(86) PCT No.: PCT/FR2006/000753

§ 371 Date: Jan. 18, 2008

(30) Foreign Application Priority Data
Apr. 21, 2005 (FR) 0504000

(51) Int. Cl. H04L 9/00; H04K 1/00

(52) U.S. Cl. 380/270

(57) ABSTRACT

The invention concerns a cryptographic device (6) comprising a terminal (1) and a mobile telephone (2) capable of exchanging data via a wireless link (5), said cryptographic device (6) being adapted to use public key cryptographic protocols with other cryptographic entities (4, 43), and the secret key of the cryptographic device is stored in the mobile telephone (2) and not in the terminal.

This invention relates to the field of secure telecommunications, and in particular remote services secured by public key systems. Such secure services include, for example, VPN connections to a private company network from an Internet network, an online electronic signature or authentication of a person according to the SSL protocol.

A cryptographic key of a public key algorithm includes a public part and a private part. The public part is generally distributed without any restriction to various users. The validity of a certificate attests to the confidence that can be had in the public key associated with an identity. A certificate standard used on the Internet is X.590v3. This standard defines a certificate including in particular:
the public key to be certified;
the identity of its holder;
the key validity period;
attributes defining the rights of use of the key: message signature key or secure Internet server key, for example; and
a cryptographic signature of this data by the private key of a certification authority transmitting the certificate.

A public key infrastructure (PKI) is used to manage certificates. A PKI infrastructure serves, on the one hand, to create certificates, but also to manage their life (recall, renewal, etc.).

To create secure access to a private company network from an Internet-type open network, the VPN technique establishes an encrypted IP tunnel between the user terminal and the company network. The VPN technique is usually based on an authentication and encryption architecture using a one-time password (OTP) generated by a calculator, a PKI architecture based on signature algorithms and certificates stored in the hard disk of the user terminal, a smart card inserted into a card reader connected to the user terminal, or a smart card integrated in a dongle connected to the USB port of the user terminal.

These various alternatives have disadvantages. The ergonomics of a one-time password generation calculator are limited; the user must first read the code on the calculator, then enter it into the terminal.

A software certificate stored on a hard disk is relatively vulnerable to attacks.

A smart card, inserted into a card reader in credit card format, or integrated in a USB dongle, requires the user to have an additional smart card, which involves an added cost and can be lost. In addition, a smart card in credit card format requires the user to have a card reader. A SIM card for a mobile telephone must be transferred to a card reader of the terminal in order to be used to generate a certificate. This transfer operation is inconvenient insofar as the SIM card is in the small “micro-SIM” format.

This invention is intended to overcome these disadvantages. The invention is also intended to use public key cryptographic applications. The invention thus relates to a cryptographic device including a terminal and a mobile telephone capable of exchanging data via a wireless connection, wherein said cryptographic device is capable of implementing public key cryptographic protocols with other cryptographic entities, and the secret key of the cryptographic device is stored in the mobile telephone and not in the terminal.

Advantageously, a theft of the terminal alone, or of the mobile telephone alone, would not enable the thief to usurp the identity of the cryptographic device according to the invention.

According to an alternative, said terminal is capable of establishing a wire or wireless connection with another cryptographic entity and capable of exchanging data with said cryptographic entity by means of this connection.

According to yet another alternative, said cryptographic entity is a server for accessing a computer network, and said data exchanges enable the terminal to be authenticated with said server.

The invention also relates to a method for implementing a public key cryptographic operation including a step of implementing public key cryptographic protocols between at least one cryptographic entity and a device including a mobile telephone storing a secret key of the device and including a terminal not storing said secret key, wherein said terminal and said mobile telephone exchange data by a wireless connection.

According to an alternative, the data exchanges of said cryptographic protocols between said cryptographic entity and said device are performed by a wire or wireless connection between said terminal and said other cryptographic entity.

According to yet another alternative, said cryptographic entity is a server for accessing a computer network and said data exchanges are exchanges for authenticating said terminal with said server.

Other features and advantages of the invention will become clear from the following description, provided as a non-limiting indication, in reference to the appended drawings, in which:

FIG. 1 shows a user's local machine connected in a VPN to a private network, according to the invention;

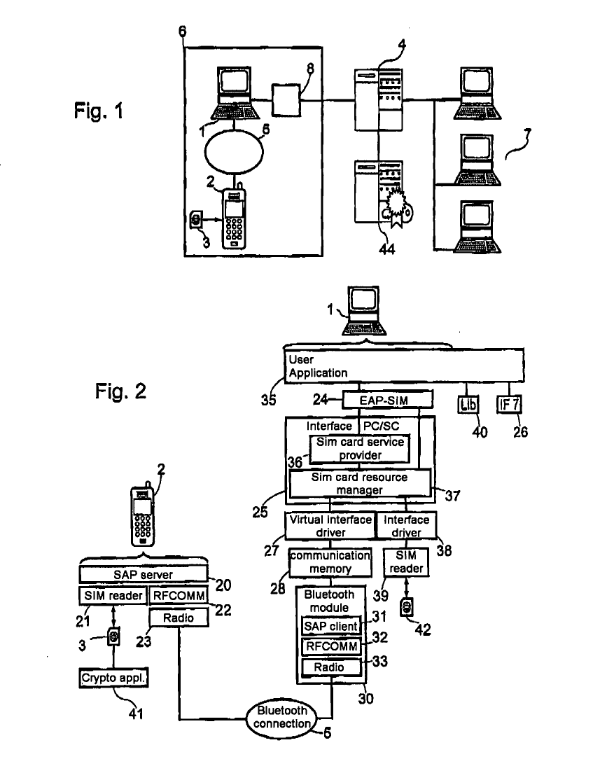

FIG. 2 shows the various software layers implemented in the user's local machine, according to the invention;

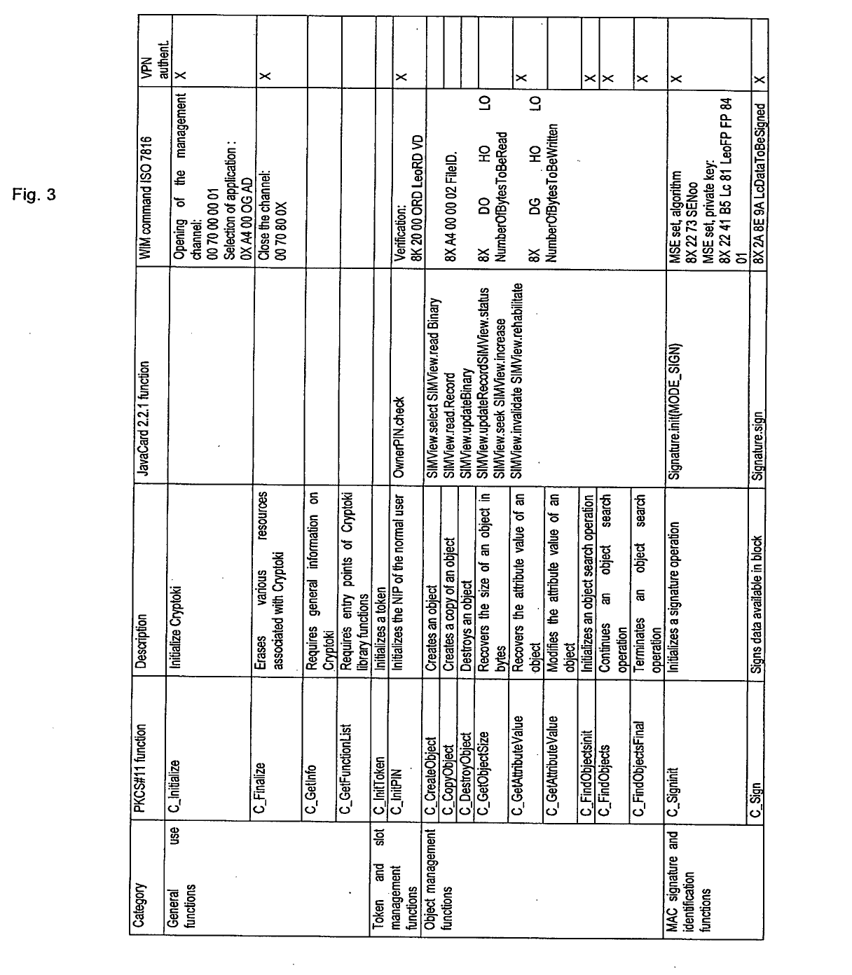

FIG. 3 shows the implementation of various PKCS#11 functions;

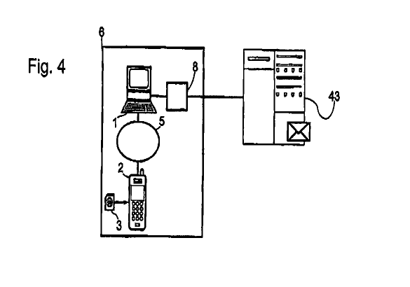

FIG. 4 shows a user's local machine connected to a signed document publication server.

The invention proposes the use of the capabilities of a smart card housed in a mobile terminal and having public key cryptographic applications. The smart card is then used as a cryptographic calculation tool in a PKI architecture, for example to implement authentication, encryption or signature functions. A terminal connected to a network has a wireless connection with the mobile terminal and a cryptographic function library. A cryptographic function called in the library transmits a cryptographic operation command to the smart card by means of the wireless connection. The smart card executes the cryptographic operation and transmits its result to the terminal.

FIG. 1 shows a user's local machine 6 according to the invention. This user's local machine 6 includes a terminal 1 equipped with a module 8 for VPN communication with a private network 7 and having access to a SIM card 3 enabling the user to be authenticated in the private network 7. The access of the terminal 1 to the private network 7 is managed by a VPN gateway 4. A server 44 has elements intended to form a PKI infrastructure, such as a registration authority and a certification authority.

The connection between the terminal 1 and the SIM card 3 is achieved by means of a wireless connection 5, for example of the Bluetooth type, between the terminal 1 and a mobile terminal 2 housing a SIM card 3 for authentication of the mobile terminal 2 in a mobile network.

In this way, the user does not need to have a specific SIM card to access the network 7 or does not need to handle the SIM card of his/her mobile terminal 2 in order to insert it into another reader connected to his/her terminal 1.

In the context of the Bluetooth protocol, the mobile terminal 2 and the terminal 1 implement a set of protocols and procedures called SAP (SIM Access Profile) developed to give access to a SIM card housed in a terminal, by means of the Bluetooth connection 5, in a completely transparent manner.

Thus, in FIG. 2, the mobile terminal 2 includes a SAP server module that exchanges messages with the SIM card 3 by means of a reader 21 according to ISO standard 7816-3, and with the Bluetooth connection 5 by means of a layer 22 implementing the RFCOMM (Serial Cable Emulation Protocol) emulating a serial connection, and a low-level layer 23 enabling a Bluetooth radio connection to be established with other terminals.

The SIM card 3 has a certain number of public key cryptographic applications, in particular making it possible to perform cryptographic authentication, encryption or signature operations.

An application using cryptographic tools 35, used in association with access to the network 7, calls on a PKCS#11 module 24 having access to a communication module 26 and to a PC/SC interface module 25 with a SIM card. The PKCS#11 24 and PC/SC 25 modules are standard. The modules 24 call on a library 40 of public key cryptographic operations when the user application 35 requires a public key cryptographic operation to be performed in the smart card 3 housed in the mobile terminal 2. The modules 24 also call on SIM card access and command functions, performed by the PC/SC interface module 25.

A function of the library 40 called by means of its programming interface by the user application 35, thus applies a cryptographic operation command on the interface module 25. The interface module 25 transmits this command in message form to a virtual pilot 27. The virtual pilot 27 relays and adapts this message to a SAP module 31. The library 40 is essential for making it possible to use public key cryptographic applications available in the smart card 3 housed in the reader 2. The library 40 is, for example, installed on a PC-type terminal 1.

The SIM card 3 housed in the terminal 2 is equipped with public key cryptographic applications 41. The cryptographic operations offered by the card can in particular include signature generation or verification, data encryption/decryption, certificate generation or authentication. These applications 41 are, for example, in the form of JavaCard applets (registered trademark) installed in the SIM card or in the form of a WIM module (for “Wireless Identity Module”) integrated in the SIM card. A WIM module is typically used by WAP navigators located in a mobile terminal.

Public key cryptographic applications 41 of the card can then be used so that the terminal 1 can execute applications using cryptographic operations, such as the VPN or the electronic signature.

The programming interface of the library 40 can be of the CAPI or the PKCS#11 type.

The PKCS#11 programming interface standard is public and free to use. This programming interface proposes low-level cryptographic functions such as the generation and storage of a key, electronic signature, or encryption and decryption of data. This programming interface is called in a certain number of software programs designed to open their cryptographic functionalities to third-party providers.

The CAPI programming interface is available exclusively on Windows platforms. This programming interface offers application security functions and signature verification and confidence certificate chain management functions. The CAPI programming interface mutualizes cryptographic resources of various user applications. Cryptographic function libraries called CSP (for “Crypto Service Provider) are interfaced under CAPI to offer security services.

An example of exchanges between the library 40 and the SIM card 3 housed in the terminal 2 is described in detail below. In this example, the application 41 of the SIM card 3 is implemented in the form of an applet and the library 40 is of the PKCS#11 type. The data is thus exchanged in ADPU (for “Application Protocol Data Unit”) form.

| Messages: | Comments: |
|---|---|
| PKCS#11 00 A4 04 | The library selects and application |
| 00 ‘Lg’ ‘Aid’ | identified by its Aid identifier |
| Applet 90 00 | The applet accepts the selection |
| PKCS#11 | The data is then exchanged in the form |
| | of ADPUs enabling, for example, the |
| | recovery of certificates, associated |
| | public keys, RSA signatures, etc. |

The table of FIG. 3 shows various PKCS#11 functions and their implementation according to JavaCard or WIM. The table also specifies the functions used in an authentication intended to form a private virtual network. The abbreviations used are the following:

RDQ: reference data qualifier, RD: reference data, VD: verification data, FP: file path, HO: high offset, LO: low offset, Lc: length of data field.

We will now describe the mechanisms of communication between terminal 1 and the SIM card 3.

Terminal 1 includes a SAP client module 31, which communicates with the SAP server module 20 by means of a layer 32 implementing the RFCOMM protocol and a low-level layer 33 for establishing a Bluetooth radio connection 5, which three layers are combined in a Bluetooth module 30.

The SAP server 20 and client 31 modules only exchange messages with the SIM card 3, and apply commands to it, such as commands to activate/deactivate the SIM card.

The SAP client module 31 is designed to execute a connection procedure with the SAP server module 20 by means of a Bluetooth connection, and a disconnection procedure. When a connection has been established, the SAP server module 20 is designed to interrogate the SIM card reader 21 and the SIM card capable of being read by the reader 21, and to send, to the SAP client module 31, information on the status of the reader 21, on the presence of a SIM card in the reader 21 and on the status of the SIM card 3.

The SAP client module 31 is in particular designed to transmit orders intended for the SIM card 3 for activation/deactivation, initialization, and command, containing APDU messages (Application Protocol Data Unit), with the SAP server module being designed to relay these commands in order to apply them to the SIM card via the reader 21. The SAP server module is also designed to notify the SAP client module 31 of any changes in status of the SIM card 3 housed in the reader 21, for example resulting from a user's action of insertion or removal of the card into or from the reader.

The PC/SC interface module 25 is designed to communicate with a plurality of smart card readers 39 (memory or microprocessor cards) or SIM cards 42, by means of drivers 38 adapted to the readers.

A virtual driver 27 is designed to relay and adapt the messages exchanged between the interface module 25 and the SAP module 31, which messages contain information exchanged with the SIM card 3. The exchange of messages between the virtual driver 27 and the SAP client 31 is, for example, performed with an exchange or communication memory 28 in which the messages to be transmitted are inserted. The virtual driver 27 is designed as a driver 38. It makes it possible in particular for the user to select a mobile terminal or to add a mobile terminal in order to pair it with its terminal 1.

To communicate with a plurality of drivers 27, 38, the PC/SC interface module includes a resource management module 37 and a service provider module 36. The resource management module 37 is designed to detect accessible smart cards and make this information available to a plurality of applications such as the user application 35. This module 37 is also designed to manage the requests for access to smart cards transmitted by the applications, and command the smart cards.

The service provider module 36 is designed to offer high-level functions to the applications, concatenating a plurality of commands applied to a smart card in order to perform a single function of accessing or processing information provided by it, which functions include in particular cryptographic or authentication functions.

FIG. 4 shows the application of the invention to the signature of documents and to their publication. A document is selected by a user of the terminal 1. An application of the terminal 1 requires that the library generate a cryptographic signature command for the SIM card 3. This command and the document are transmitted to the mobile terminal 2 and to the SIM card 3 according to the mechanisms described above. The SIM card 3 processes the command and provides the cryptographic signature with a cryptographic application that it stores. The SIM card 3 transmits the signed document to the terminal 1. The terminal 1 then transmits the signed document to a server 43 for publication of signed documents.

Although the example above has been described in the context of a wireless Bluetooth connection between the mobile terminal and terminal 1, the invention can also be applied to a case in which this wireless connection is of a different type. A person skilled in the art can in particular envisage a proximity wireless connection of the IrDA (infrared) type or of the contactless NFC type (defined in ISO standard 14443). It is then sufficient to provide the mobile terminal with a software module for accessing the SIM for polling the IrDA or contactless ports, as the case may be, and to provide the terminal 1 with a specific PC/SC interface 25 for communication with this polling software module. For a wireless NFC connection, a mobile terminal 2 of the type in card emulation mode can pass as a contactless card. If the SIM card 3 is connected to its contactless communication module, the module 25 of the terminal 1 can access the cryptographic applications of the SIM card.

In addition, although the invention has been described in terms of its use in the formation of a VPN connection or in the publication of signed documents, the invention can also be applied to other applications, and in particular to the authentication of a user when he/she connects to any network and in particular to an IP network such as the Internet.

1-6. (canceled)

7. A cryptographic device comprising a terminal and a mobile telephone capable of exchanging data via a wireless connection, wherein said cryptographic device is capable of implementing public key cryptographic protocols with other cryptographic entities, and the secret key of the cryptographic device is stored in the mobile telephone and not in the terminal.

8. The cryptographic device according to claim 7, in which said terminal is capable of establishing a wire or wireless connection with another cryptographic entity and is capable of exchanging data with said cryptographic entity by means of this connection.

9. The cryptographic device according to claim 8, in which said other cryptographic entity is a server for accessing a computer network, and said data exchanges enable the terminal to be authenticated with said server.

10. The cryptographic device according to claim 7, wherein the wireless connection is an NFC connection.

11. A method for implementing a public key cryptographic operation, including a step of implementing public key cryptographic protocols between at least one cryptographic entity and a cryptographic device including a mobile telephone storing a secret key of the device and including a terminal not storing said secret key, wherein said terminal and said mobile telephone exchange data by a wireless connection.

12. The method according to claim 11, in which the data exchanges of said cryptographic protocols between said cryptographic entity and said device are performed by a wire or wireless connection between said terminal and said other cryptographic entity.

13. The method according to claim 12, in which said other cryptographic entity is a server for accessing a computer network and said data exchanges are exchanges for authenticating said terminal with said server.

14. A mobile telephone intended to operate in a cryptographic device, comprising a terminal capable of exchanging data via a wireless connection with said mobile telephone in order to implement public key cryptographic protocols with other cryptographic entities, wherein said mobile telephone stores the secret key of said cryptographic device.

15. The mobile telephone according to claim 14 further comprising a smart card, wherein the smart card is housed in the mobile telephone.

16. Use of the cryptographic device according to claim 7 in order to provide a remote service secured by public key cryptographic protocols.
